(19) United States
(12) Patent Application Publication
(10) Pub. No.: US 2013/0096765 A1
(43) Pub. Date: Apr. 18, 2013

(54) PARKING AREA DETECTION SYSTEM AND METHOD USING MESH SPACE ANALYSIS

(71) Applicant: Chan Seok Jun, Anyang (KR)

(72) Inventor: Chan Seok Jun, Anyang (KR)

(73) Assignee: HYUNDAI MOTOR COMPANY, Seoul (KR)

(21) Appl. No.: 13/323,158

(22) Filed: Dec. 12, 2011

(30) Foreign Application Priority Data
Oct. 14, 2011 (KR) 10-2011-0105455

(51) Int. Cl. G01S 15/00; G05D 1/00

(52) U.S. Cl. 701/23; 367/87

(57) ABSTRACT

A parking area detection system and method is disclosed which uses mesh space analysis to virtually divide a space to be detected in a mesh shape having a lattice structure and sequentially excludes a lattice region in which an obstacle is not recognized based on a recognition signal by the ultrasonic sensor. Thus the parking area detection system is able to prevent information distortion from occurring in a space recognition process.

### CROSS-REFERENCES TO RELATED APPLICATIONS

The priority of Korean patent application No. 10-2011-105455 filed on Oct. 14, 2011, the disclosure of which is hereby incorporated in its entirety by reference, is claimed.

### BACKGROUND OF THE INVENTION

1. Field of the Invention

The present invention relates to technology for detecting a parking area for a vehicle, and more particularly, to parking area detection system and method using mesh space analysis which, when detecting a parking area uses an ultrasonic sensor, virtually divides a space to be detected in a mesh shape having a lattice structure and sequentially excludes a lattice region in which an obstacle is not recognized based on a recognition signal by the ultrasonic sensor, thereby preventing information distortion from occurring in a space recognition process.

2. Description of the Related Art

Automobiles have become a necessary component of modern society. In particular, automobiles have emerged as an indispensable form of transportation in the modern world and as a result the automobile industry has expanded rapidly.

One of the biggest challenges in driving for most individuals is parking. As a result automatic parking systems have been developed and applied to numerous types of vehicles.

Generally, automatic parking systems scan a parking area using an ultrasonic sensor mounted in a vehicle and alert the driver when an obstacle is at risk of coming in contact with the vehicle should the driver proceed further. At this time, since beams transmitted from the ultrasonic sensor are scanned in a shape having a predetermined width, error sometimes occur when the size and position of the obstacle is recognized based on the received signal.

FIG. 1 is a view illustrating a parking area detection method in the related art in detail. As shown in FIG. 1, an ultrasonic sensor mounted on the lateral side of a vehicle detects a corresponding space while the vehicle moves into a parking spot. The parking area detection process calculates a distance based upon the reflection time between the object and a reception unit mounted to a car (i.e., the time it takes for an ultrasonic signal to bounce back off of the object to the reception unit). At this time, the ultrasonic wave/signal transmitted in the transmission unit is transmitted in a radial beam having a scanning angle of about 15 degrees and a reception unit receives the signal reflected from an object closest to the vehicle. Therefore, a recognition distortion phenomenon occurs. A recognition distortion phenomenon is a phenomenon in which the obstacle has gradually curved corners due to recognition information indicated by a solid line at corners of the obstacle, that is, in an interface between the obstacle and a non-obstacle, compared to the substantial obstacle having rectangular corners as shown in FIG. 1.

Accordingly, in the parking area detection process, upon determining the size and position of the obstacle, a predetermined distorted error may occur. Thus, it is difficult to perform the accurate parking control and prevent accidents from occurring due to incorrect on the part of the device.

### SUMMARY OF THE INVENTION

Various aspects of the present invention have been made in view of the above problems, and provide parking area detection system and method using mesh space analysis which, when detecting a parking area using an ultrasonic sensor, virtually divides a space to be detected in a mesh shape having a lattice structure and sequentially excludes a lattice region in which an obstacle is not recognized based on a recognition signal by the ultrasonic sensor, thereby preventing information distortion from occurring in a space recognition process.

According to an aspect of the present invention, a parking area detection system using mesh space analysis is provided. The system may include: a transmission unit, (e.g., a transmitter) configured to transmit an ultrasonic signal; a reception unit, (e.g., a receiver) configured to receive a reflection signal in which the ultrasonic signal transmitted from the transmission unit is bounced off an obstacle and returned back to the reception unit mounted on the vehicle; a mesh space setting unit configured to set a virtual area with respect to an estimated parking area in which the ultrasonic signal is transmitted by the transmission unit, and to store a mesh type space image in which a corresponding region is divided into area lattice structure; a non-obstacle region determination unit configured to analyze the reflection signal and determine a non-obstacle region on the mesh space image; and a controller configured to exclude the non-obstacle region determined by the non-obstacle region determination unit from the mesh type space image and calculate a final space analysis result as the mesh type space image excluding the non-obstacle region.

The mesh space setting unit, the non-obstacle region determination unit, and the controller may be integrated into control unit. The control unit may be, for example, electronic control unit (ECU).

When opposing results are received at the same time while the reflection signal is being analyzed, the non-obstacle region determination unit may further be configured determine the region on the mesh type space image that corresponds to the point as the non-obstacle region. Furthermore, the controller may be configured to output a final parking information obtained by the calculated final space analysis result to an automatic parking control system.

According to another aspect of the present invention, a parking area detection method using mesh space analysis is provided. The method may include: transmitting, by a transmission unit, an ultrasonic signal; setting, by a mesh space setting unit, a virtual area with respect to a an estimated parking area in which the ultrasonic signal is transmitted by the transmission unit and forming, by the first unit, a mesh type space image in which a corresponding area is divided into a lattice structure; interpreting, by a non-obstacle region determination unit, a reflection signal in which the ultrasonic signal transmitted by the transmission unit is bounced off on an obstacle and returned back to a receiver and determining a non-obstacle region on the mesh type space image; and excluding, by a controller, the determined non-obstacle region detected by the second unit and calculating, by the controller, a final space analysis result.

As described above in the description of the system architecture, when opposing results are received at the same point in a process of analyzing the reflection signal, the non-obstacle region may be determined by determining the region on the mesh type space image of a detection target region corresponding to the point as the non-obstacle region.

The method may further include outputting the final parking information from the controller to an automatic parking control system.

The method may be performed by programmable logic implemented in an electronic control unit (ECU) as computer readable media stored on a computer readable medium.

According to the system and method of the exemplary embodiment of the present invention, it is possible to precisely detect the size and position of an obstacle without any error due to distortion when detecting a parking area, performing precise parking control and executing safe parking guidance and automatic parking.

The systems and methods of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view illustrating a parking area detection method in the conventional art.

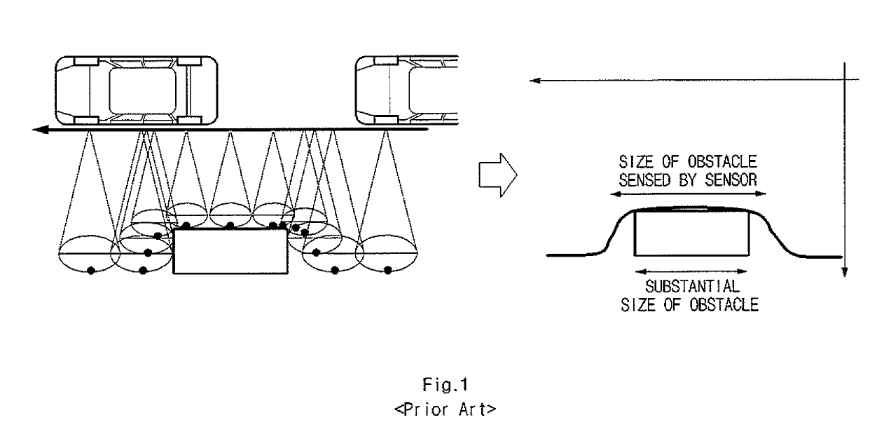

FIG. 2 is a functional block diagram illustrating a main configuration of a parking area detection system using mesh space analysis according to an exemplary embodiment of the present invention.

FIG. 3 is a sequence diagram illustrating an operation of the parking area detection system having the configuration of FIG. 2.

FIG. 4 is a view illustrating a space analysis result according to an exemplary embodiment of the present invention.

### DETAILED DESCRIPTION

Reference will now be made in detail to various embodiments of the present invention(s), examples of which are illustrated in the accompanying drawings and described below. Like reference numerals in the drawings denote like elements. When it is determined that detailed description of a configuration or a function in the related disclosure interrupts understandings of embodiments in description of the embodiments of the invention, the detailed description will be omitted.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

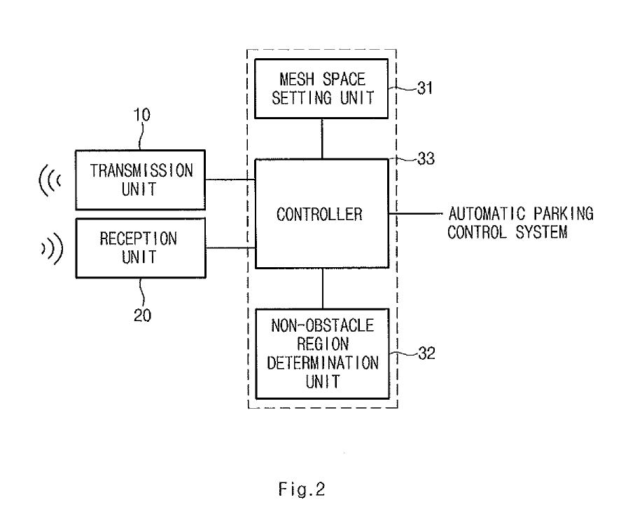

FIG. 2 is a functional block diagram illustrating a main configuration of a parking area detection system using mesh space analysis according to an exemplary embodiment of the present invention. In FIG. 2, the reference numeral 10 is a transmission unit, e.g., a transmitter, which transmits an ultrasonic signal. The reference numeral 20 is a reception unit, e.g., a receiver, which receives a reflection signal in which the ultrasonic signal transmitted in the transmission unit 10 is bounced off an object and returned back to the reception unit.

The reference numeral 31 is a mesh space setting unit which sets or configures a virtual area with respect to the estimated parking area. The virtual area is perceived by scanning ultrasonic waves output by the transmission unit 10. The mesh space setting unit then stores, as data, a mesh space image in which a corresponding region is divided into a lattice structure. The reference numeral 32 is a non-obstacle region determination unit which analyzes the reflection signal received through the reception unit 20 and determines a non-obstacle region with respect to the mesh type divided region set by the mesh space setting unit 31. The reference numeral 33 is a controller which excludes the non-obstacle region determined by the non-obstacle region determination unit 32, calculates a final space analysis result as the mesh type space image excluding the non-obstacle region, and transmits final parking information obtained from the calculated space analysis result to an automatic parking control system. In some embodiments, the mesh space setting unit 31, the non-obstacle region determination unit 32, and the controller 33 may be integrated into a control unit generally called an electronic control unit (ECU).

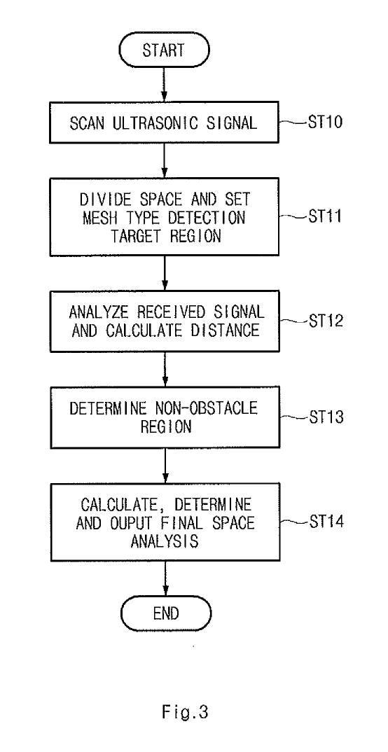

Subsequently, an operation of the system having the above configuration will be described with reference to a sequence diagram of FIG. 3. When the parking area detection function is executed, the controller 33 first controls the transmission unit 10 to scan ultrasonic signals (waves) to a detection target region (ST10). Subsequently, the controller 33 controls the mesh space setting unit 31 to compute a virtual space image with respect to a region in which the ultrasonic signals were scanned and divide a corresponding space into a lattice structure, thereby set the detection target region (ST11).

When the reflection signal is received from the reception unit 20, the controller 33 transmits the received reflection signal to the non-obstacle region determination unit 32. The non-obstacle region determination unit 32 calculates a distance to an object on the basis of the received reflection signal (ST12), and synthetically/virtually analyzes the distance to determine the non-obstacle region (ST13). The reflection signal may provide opposing information at the same point due to certain characteristics of the ultrasonic signal. That is, the ultrasonic signal is output in radially having an angle of about 15 degrees to exhibit dot scans or surface scans and thus a difference in a reflection position of the signal at the same position would occur. As a result, opposing recognition results are represented in the determination of present/absence of the obstacle for the same point.

When the non-obstacle region determination unit 32 receives opposing recognition results in the process of computing and analyzing the received signal, the non-obstacle region determination unit 32 determines a corresponding point, that is, a cell corresponding to the corresponding point in an image of the detection target region having the mesh structure to the non-obstacle region.

The controller 33 then calculates a space analysis result on the basis of the non-obstacle region determined by the above-described process and outputs obtained parking information to an automatic parking control system (ST14). That is, according to the exemplary embodiment, it is possible to precisely detect the size and position of an obstacle without any errors due to distortion when detecting a parking area so that it is possible to perform more precise parking control and provide the parking area detection technology capable of executing a safe parking guidance and automatic parking.

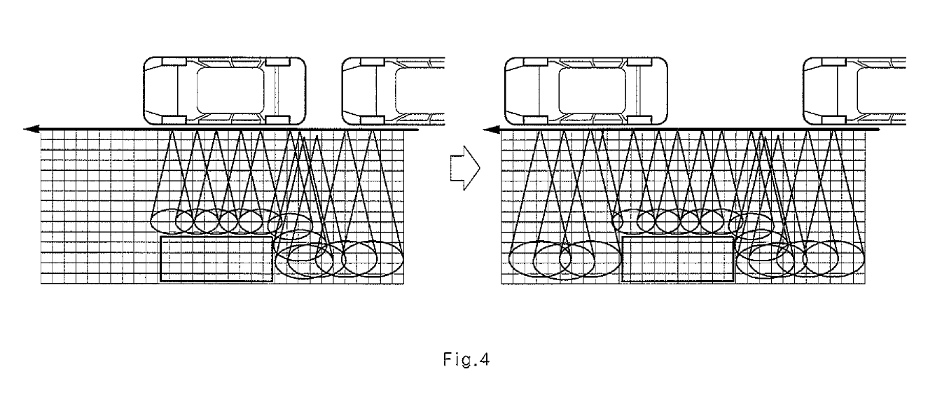

FIG. 4 illustrates a space analysis result according to an exemplary embodiment.

Furthermore, the control logic of the present invention may be embodied as computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1. A parking area detection system using mesh space analysis, the system comprising:
a transmission unit configured to transmit ultrasonic signals;
a reception unit configured to receive reflection signals in which the ultrasonic signals transmitted from the transmission unit is bounced off an obstacle and returned back to the reception unit;
a mesh space setting unit configured to set a virtual area with respect to an estimated parking area to which the ultrasonic signals are transmitted by the transmission unit and to store a mesh type space image in which a corresponding region is divided into a lattice structure;
a non-obstacle region determination unit configured to analyze the reflection signals and determine a non-obstacle region on the mesh type space image; and
a controller configured to exclude the non-obstacle region determined by the non-obstacle region determination unit from the mesh type space image and calculate a final space analysis result as a mesh type space image excluding the non-obstacle region.

2. The system of claim 1, wherein the mesh space setting unit, the non-obstacle region determination unit, and the controller are integrated into a control unit.

3. The system of claim 2, wherein the control unit is an electronic control unit (ECU).

4. The system of claim 1, wherein when opposing results are received at a same point in a process of analyzing the reflection signal, the non-obstacle region determination unit determines the region on the mesh type space image corresponding to the point as the non-obstacle region.

5. The system of claim 1, wherein the controller is configured to output a final parking information obtained by the calculated final analysis result to an automatic parking control system.

6. A parking area detection method of a vehicle using mesh space analysis, the method comprising:
transmitting, by a transmission unit, ultrasonic signals according to a predetermined control signal;
setting, by a mesh space setting unit, a virtual area with respect to an estimated parking area in which the ultrasonic signals are transmitted by the transmission unit and forming a mesh type space image in which a corresponding area is divided into a lattice structure;
interpreting, by a second-non-obstacle region determination unit, a reflection signal in which the ultrasonic signals transmitted by the transmission unit is bounced off an obstacle and returned back to a receiver, and determining a non-obstacle region on the mesh type space image; and
excluding, by a controller, the determined non-obstacle region from the mesh type space image and calculating a final space analysis result as the mesh type space image excluding the non-obstacle region.

7. (canceled)

8. The method of claim 6, wherein determining the non-obstacle region includes determining the region of the mesh type space image corresponding to the point as the non-obstacle region when opposing results are received at the same point in a process of converting and analyzing the received signal.

9. The method of claim 6, further comprising outputting, by the controller, a final parking information obtained by the calculated final space analysis result to an automatic parking control system.

10. The method of claim 6, wherein the method is executed by a control unit including programmable logic implemented in an electronic control unit (ECU).

11. A non-transitory computer readable medium containing program instructions executed by a control unit, the computer readable medium comprising:
program instructions that set a virtual area with respect to an estimated parking area in which ultrasonic signals are transmitted by a transmission unit;
program instructions that form a mesh type space image in which a corresponding area is divided a lattice structure;
program instructions that interpret a reflection signal in which the ultrasonic signals transmitted by the transmission unit is bounced off an obstacle and returned back to a receiver;
program instructions that determine a non-obstacle region on the mesh type space image;
program instructions that exclude the determined non-obstacle region from the mesh type space image; and
program instructions that calculate a final space analysis result as the mesh type space image excluding the non-obstacle region.

12.-14. (canceled)
